(19) United States
(12) Patent Application Publication
(10) Pub. No.: US 2025/0288170 A1
(43) Pub. Date: Sep. 18, 2025

(54) HEAD FOR A SUCTION DEVICE AND A METHOD OF CONTROLLING SAME

(71) Applicant: TRACENSE SYSTEMS LTD., Netanya (IL)

(72) Inventors: Tomer KATZ, Tel Aviv (IL); Gil SHANI, Giv’at Shapira (IL); Ziv ALPERSON, Kfar Yona (IL); Ami KAMIL, Be'erotayim (IL)

(21) Appl. No.: 19/121,881

(22) PCT Filed: Apr. 10, 2023
(86) PCT No.: PCT/IL2023/050381

§ 371 Date: Apr. 17, 2025

(30) Foreign Application Priority Data
Apr. 11, 2022 (IL) 292157

(51) Int. Cl. A47L 9/08; A47L 9/00; A47L 9/24; A47L 9/28

(52) U.S. Cl. CPC A47L 9/08; A47L 9/0072; A47L 9/248; A47L 9/2805; A47L 9/2842

(57) ABSTRACT

A head for a suction device is disclosed. The head. comprising: at least one suction inlet, configured to provide suction in a first direction; at least one suction tube, wherein each suction tube is in fluid connection to each suction inlet, wherein each suction tube is further connectable to a pump; a plurality of radial outlets, configured to provide air in a radial direction, wherein the radial outlets are in fluid connection with at least one chamber connectable to at least one blower, and at least one forward outlet configured to provide air in a second direction, wherein each forward outlet is in fluid connection to the at least one chamber connectable to the at least one blower. The suction device may include a holder for holding a sensor. The holder may be located in the suction tube.

### CROSS-REFERENCE TO RELATED APPLICATIONS

This application claims the benefit of priority to Israeli Application No. 292157 filed on Apr. 11, 2022, titled “HEAD FOR A SUCTION DEVICE AND A METHOD OF CONTROLLING SAME”, the contents of which are incorporate herein by reference in their entirety.

### FIELD OF THE INVENTION

The present invention relates generally to suction devices. More specifically, the present invention relates to heads for suction devices to be used, for example, for particle detection or analysis.

### BACKGROUND OF THE INVENTION

Conventional suction devices (e.g., household vacuums) are designed to separate particles from a surface by inducing suction on the surface through a negative pressure gradient. If the adherence of a particle to a surface is weaker than the suction power, the particle will be detached from the surface and pulled in by the suction device. Solutions to increasing the detachment of particles from a surface mainly consist of improving the suction power of the device. Conventional suction devices are able to increase suction power by: improving the power of the pump inducing suction, or contacting the surface with the device improving vacuum potential and additionally scuffing the surface with optional brushes to reduce adherence of particles to the surface. However, contacting the surface with a vacuum head limits the spot of particle collection to the size of the vacuum head.

Chemical and/or physical analysis of target particles are known methods for detection of minor amounts of suspicious materials, for example, explosives on surfaces. In conventional explosive detection, suction devices are used to collect particles from a surface and chemically analyze the particles to detect target particles, such as, explosive material or narcotics. This may be done by waving a suction device over a large area, where the user may not know where explosive material may be located. This practice is limited by the effective suction area that the suction device is capable of collecting particles from, which can increase the amount of time needed to scan large areas for explosive material. In an additional detection method, particles are being collected on a surface of a carrier which is later inserted into a chemical analyzer.

Accordingly, there is a need for a suction device that can detach particles from a surface and collect them, for example, for chemical analysis, without needing to increase a pumping power or contact the surface.

### SUMMARY OF THE INVENTION

Embodiments of the present invention are directed to head for a suction device, comprising: at least one suction inlet, configured to provide suction in a first direction; at least one suction tube, wherein each suction tube is in fluid connection to each suction inlet, wherein each suction tube is further connectable to a pump; a plurality of radial outlets, configured to provide air in a radial direction, wherein the radial outlets are in fluid connection with at least one chamber connectable to at least one blower, and at least one forward outlet configured to provide air in a second direction, wherein each forward outlet is in fluid connection to the at least one chamber connectable to the at least one blower. In some embodiments, the suction device may include a holder for holding a sensor. In some embodiments, the holder may be located in the suction tube.

In some embodiments, the second direction is opposite to the first direction. In some embodiments, the second direction is set at: a tangential angle of 15-60 degrees along a plane orthogonal of the first direction, and a radial angle of 15-60 degrees with respect to the first direction. In some embodiments, the radial direction is 60-120 degrees with respect to the first direction. In some embodiments, a diameter of the head is 60-120 mm.

In some embodiments, the diameter of each at least one suction inlet is 4-10 mm. In some embodiments, the distance from each at least one suction inlet to each forward outlet is 5-20 mm. In some embodiments, the at least one forward outlet comprises a plurality of evenly distributed ports, circumferentially located around an outer radius of the at least one suction inlet. In some embodiments, each forward outlet comprises a port shape selected from: a circle, and an ellipse. In some embodiments, the plurality of radial outlets comprises a plurality of evenly spaced ports, located on a wall of the head in the radial direction.

In some embodiments, each radial outlet comprises a port shape selected from: a circle, a square, and a rectangle. In some embodiments, each suction inlet port further comprises a countersink inlet port selected from: a fillet, a chamfer. In some embodiments, each of the at least one pump is capable of pumping air at a rate of 5-30 liters per minute. In some embodiments, the at least one blower is capable of providing air at a rate of 100-1000 liters per minute. In some embodiments, the head is further comprised of a switch capable of actuating to provide air to at least one of: the radial outlets, the at least one forward outlet. In some embodiments, head further comprises a controller configured to: control the at least one pump to continuously pump air via the at least one suction tube; control the at least one blower to, either separately or simultaneously: control a radial airflow via the radial outlets, and control a forward airflow via the forward outlets.

In some embodiments, the head further comprises a distance sensor located on the head, wherein the controller is capable of receiving a signal from the distance sensor. In some embodiments, the controller is capable of controlling the air provision rate of the at least one blower based on a signal from the distance sensor. In some embodiments, the at least one blower is capable of being controlled with respect to air provision rate, activation and deactivation.

In some embodiments, the head further comprises a sensor wherein the sensor is capable of: sensing a predetermined plurality of particulates, and sending a signal to an external device. In some embodiments, the head further comprises a heating element located in proximity to at least one of: the at least one suction tube, the at least one chamber, further capable of being controlled by the controller. In some embodiments, the head further comprises a laser curtain configured to direct at least one laser beam in the second direction. In some embodiments, the head further comprises an ultrasonic transducer, configured to produce an ultrasonic vibration in the second direction. In some embodiments, the head further comprises at least one second blower, wherein the at least one second blower is configured to provide air to a second chamber, wherein the second chamber is in fluid connection to either: the at least one forward outlet, the plurality of radial outlets. In some embodiments, the head comprises of a single blower and a single chamber.

Some additional aspects of the invention are directed to a suction system, comprising: a sensor; at least one pump; at least one blower; and a suction head, comprising: at least one suction inlet, configured to provide suction in a first direction; at least one suction tube comprising a holder for holding the sensor, wherein each suction tube is in fluid connection to each suction inlet, wherein each suction tube is further connected to each pump; a plurality of radial outlets, configured to provide air in a second direction, wherein the radial outlets are in fluid connection with at least one chamber connected to the at least one blower; at least one forward outlet configured to provide air in a second direction, wherein each forward outlet is in fluid connection to the at least one chamber connected to the at least one blower, and a controller, configured to: control the at least one pump to continuously pump air via the at least one suction tube, and control the at least one blower to, either separately or simultaneously: control a radial airflow via the radial outlets, and control a forward airflow via the forward outlets.

Some additional aspects of the invention are directed to a method of controlling a suction device, comprising: activating a suction intake to induce suction of particles on a surface; controlling at least one of: a radial jet and a forward flow, to separate particles from a surface. In some embodiments, the radial jet and forward flow are alternated, and wherein alternation is for a predetermined time period.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A, 1B, 1C and 1D are illustrations of a head for a suction device according to some embodiments of the invention;

FIGS. 2A, 2B, 2C and 2D detail a portion of a suction head according to some embodiments of the invention;

FIGS. 2E and 2F are illustrations of a flow field of a suction head according to some embodiments of the invention;

FIG. 3 is an illustration of a suction device according to some embodiments of the invention;

FIG. 4A is a block diagram of a suction system according to some embodiments of the invention, and

FIG. 4B is a flowchart of a method of controlling a suction device according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of the same or similar features or elements may not be repeated.

Some aspects of the present invention are directed to a head for a suction device capable of inducing suction and providing air in a plurality of directions, including a radial direction and a forward flow direction, for example, flow outflowing from the suction device towards a surface of interest, for example, in the form of a continuous or pulsating flow. In some embodiments, to improve suction, as the head induces suction on a surface, a radial outflow substantially perpendicular to the suction direction is provided to improve the capture distance of particles on the surface by directing particles towards a suction inlet. In some embodiments, to further encourage the detachment of particles from the surface, a forward outflow substantially opposite to the suction direction is provided to detach particles from the surface. In some embodiments, while air is being pumped via the suction inlet into the suction device, a blower is simultaneously capable of providing air in a plurality of directions, including a radial for producing the radial outflow or a forward direction for producing the forward outflow. In some embodiments, air provision may be actuated between a plurality of separate outlets located on the suction head during operation, for example, to actuate between radial and forward outflows.

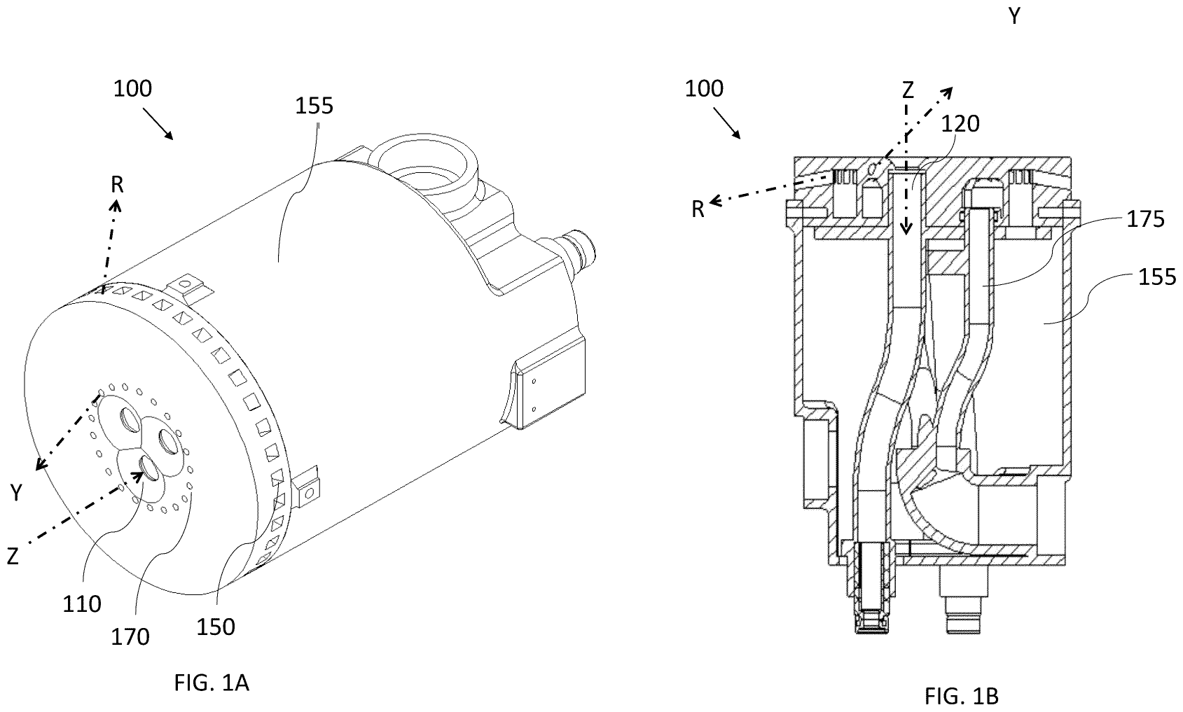

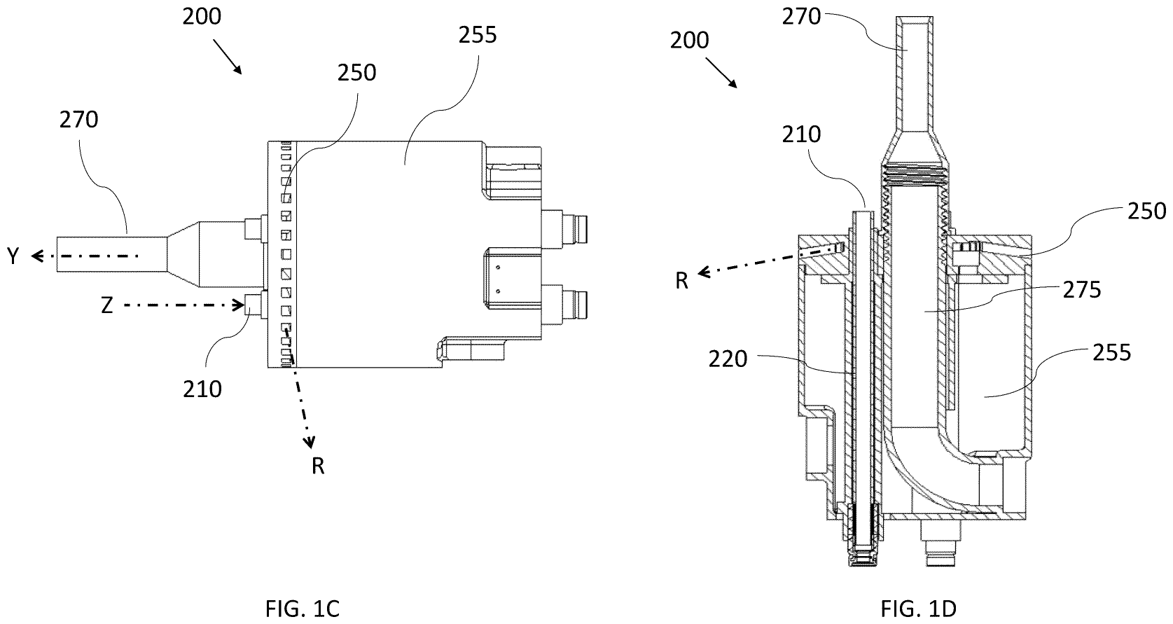

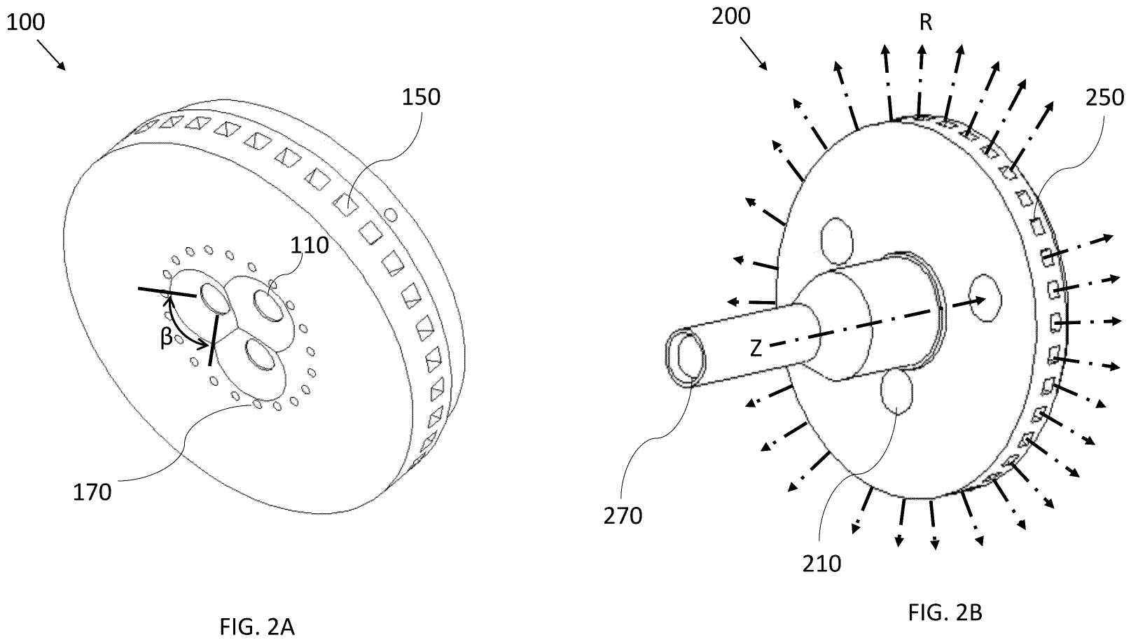

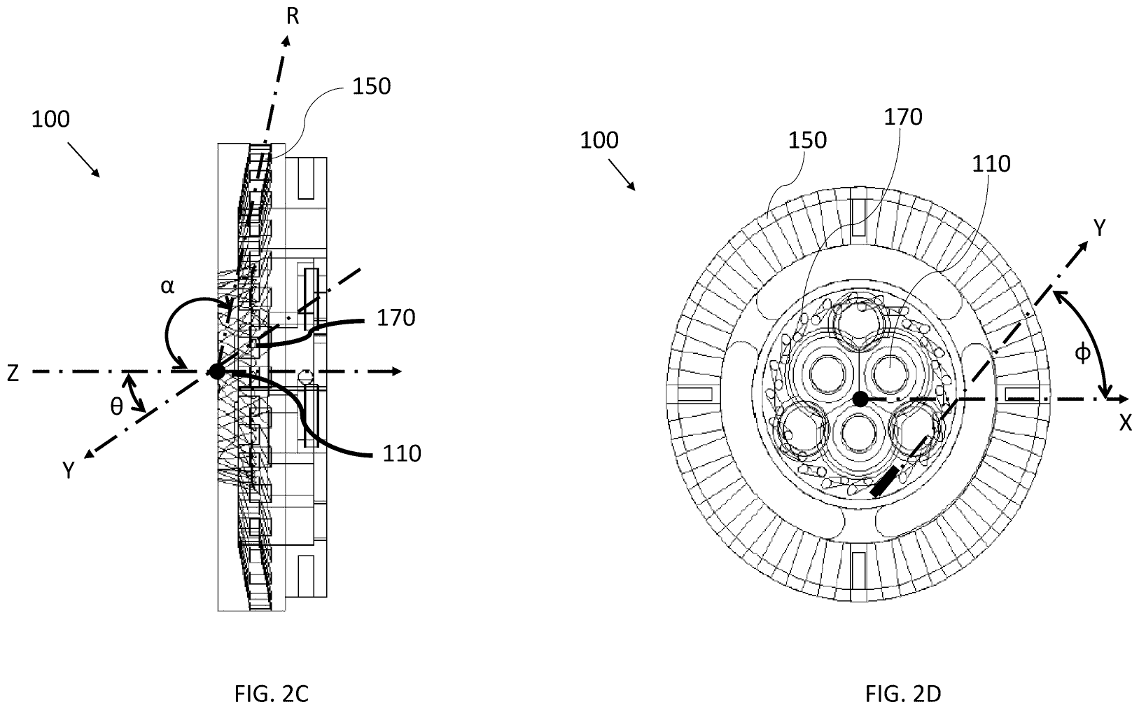

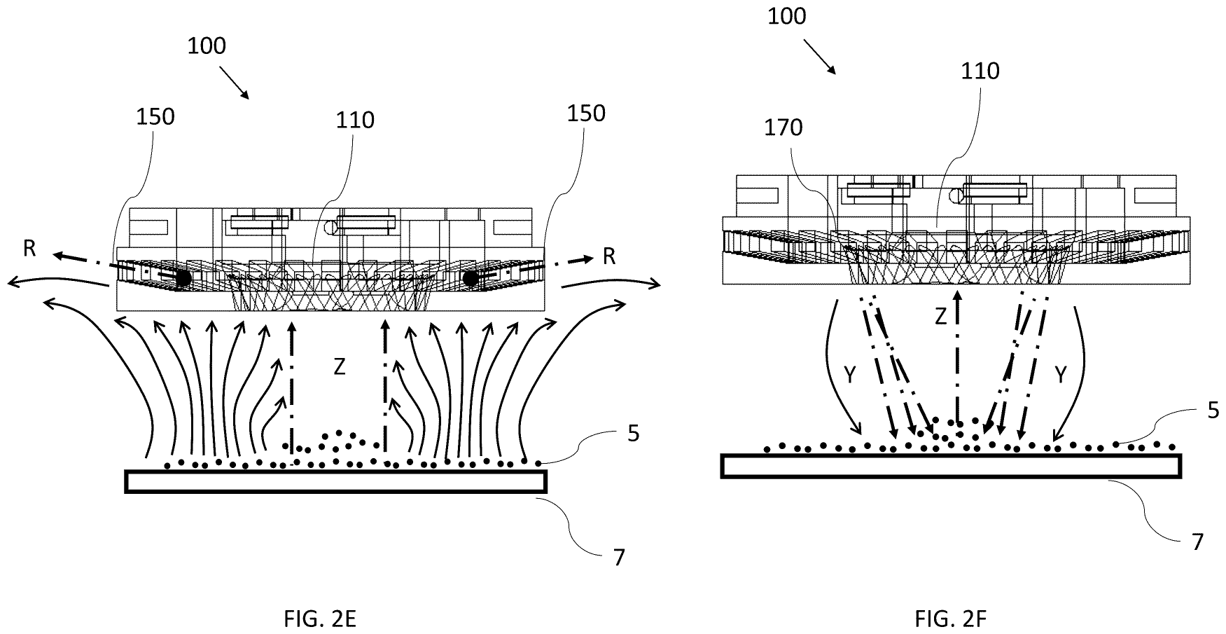

Reference is now made to FIGS. 1A and 1B which are illustrations of a head for a suction device according to some embodiments of the invention. A suction head 100 may include at least one suction inlet 110, a plurality of radial outlets 150, and at least one forward outlet 170. In some embodiments, at least one suction inlet 110 is configured to provide suction in a first direction Z. In some embodiments, first direction Z is substantially perpendicular to a surface from which the particles are to be suctioned. In some embodiments, the plurality of radial outlets 150 are configured to provide air in a radial direction R in order to create a radial outflow that improves the suction of particles from the surface. In some embodiments, the at least one forward outlet 170 is configured to provide air in a second direction Y. In some embodiments, radial direction R and second direction Y are configured in relation to first direction Z, further illustrated and discussed with respect to FIGS. 2A, 2B, 2C and 2D herein below.

In some embodiments, a suction head 100 may have a diameter of 60-120 mm, for example, 70-110 mm, 80-120 mm and any range and value herein between. In some embodiments, each suction inlet 110 may have a diameter of 4-10 mm. In some embodiments, the distance from each suction inlet 110 to neighboring forward outlet 170 may be 5-20 mm, 5-10 mm, 10-20 mm and any range and value herein between. In some embodiments, each suction inlet 110 further comprises a countersink inlet port, wherein the shape of the port is selected from: a fillet, and a chamfer, further illustrated and discussed with respect to FIG. 2A hereinbelow.

In some embodiments, the at least one forward outlet 170 comprises a plurality of evenly distributed ports, circumferentially located around an outer radius of the at least one suction inlet 110. In some embodiments, each forward outlet 170 comprises a port shape selected from: a circle, and an ellipse. In some embodiments, each forward outlet 170 may be further comprised of a countersunk outlet port, selected from: a fillet, and a chamfer. In some embodiments, each forward outlet 170 may be configured to provide air in second direction Y in order to separate particles from a surface by inducing a pulse of forward airflow on said surface. In some embodiments, said airflow may be substantially perpendicular to the surface. In some embodiments, said airflow may be configured at a predetermined angle to the surface discussed herein below in order to induce a vortex airflow on said surface.

In some embodiments, the plurality of radial outlets 150 comprises a plurality of evenly spaced ports, located on a wall of suction head 100 in the radial direction R. In some embodiments, each radial outlet 150 comprises a port shape selected from: a circle, a square, and a rectangle. In some embodiments, each radial outlet 150 may be further comprised of a countersunk outlet port, selected from: a fillet, and a chamfer.

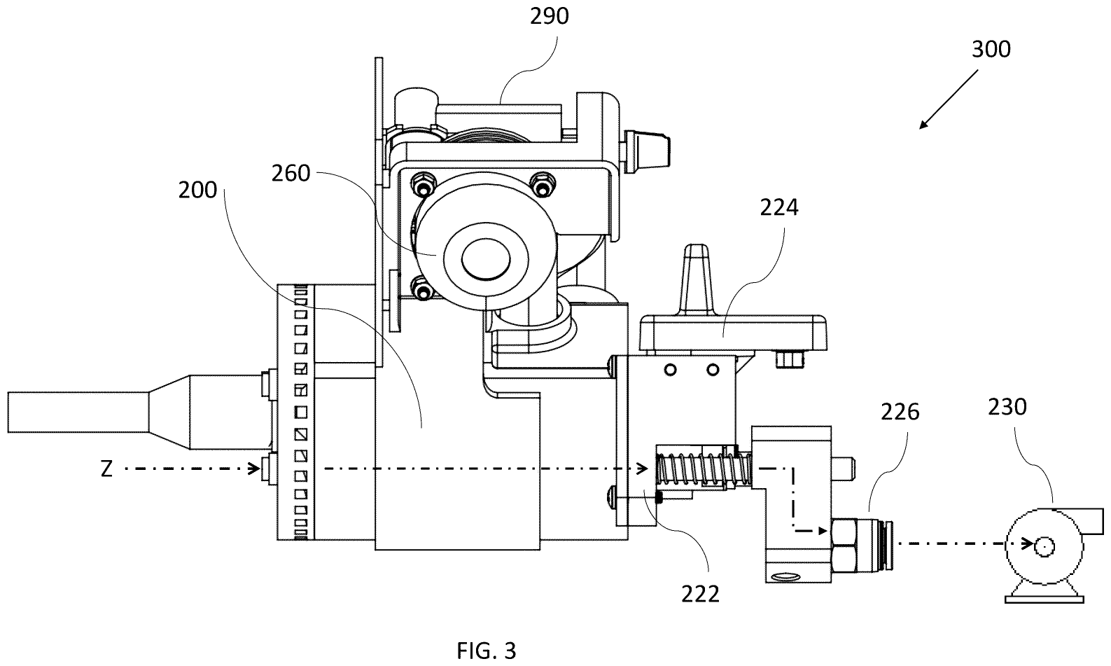

Suction head 100 may further include at least one suction tube 120 in fluid connection to each suction inlet 110. In some embodiments, suction tube 120 may further comprise a holder for holding a sensor for sensing target particles, not illustrated. An example for a holder 222 and a sensor 244 is further discussed with respect to FIG. 3 hereinbelow. In some embodiments, as suction is induced by suction head 100 to collect particles, said particles may be detected by sensor 124 and chemically analyzed to identify a predetermined desired set of particulates, e.g., traces of explosives, narcotics, and the like.

In some embodiments, suction head 100 may further include at least one chamber 155 in fluid connection with the plurality of radial outlets 150. In some embodiments, suction head 100 may further include at least a second chamber 175 in fluid connection with the at least one forward outlet 170. In some embodiments, at least one chamber 155 and at least one chamber 175 are connectable to at least one blower not illustrated. An example for a blower 260 is discussed with respect to FIG. 3 hereinbelow. In some embodiments, each one of chamber 155 and chamber 175 are connectable to separate blowers, further discussed hereinbelow. In some embodiments, chamber 150 and chamber 175 are the same chamber connected to a single blower or two separate blowers.

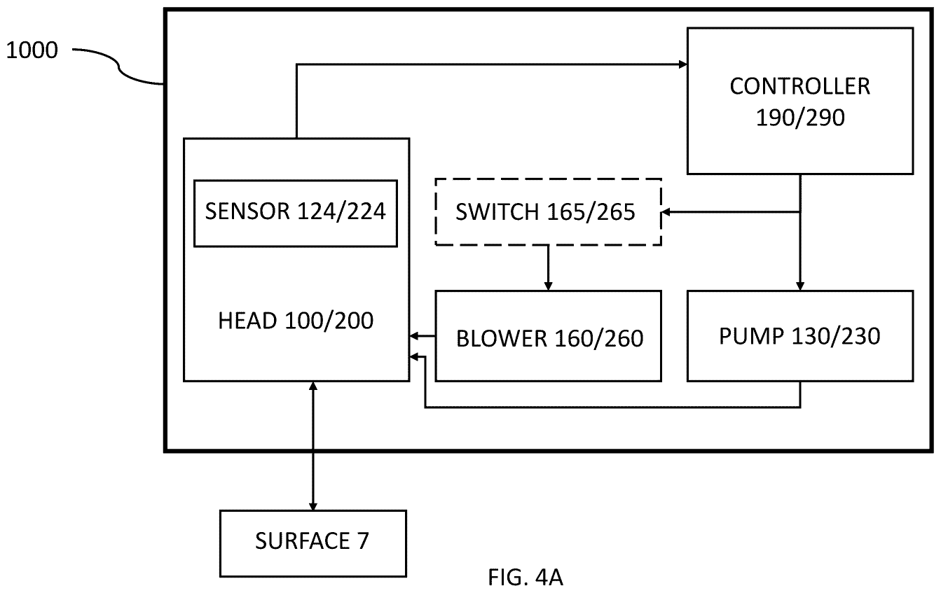

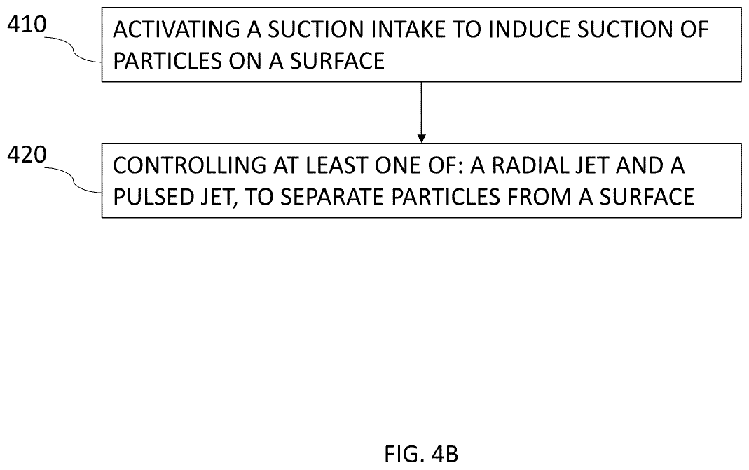

In some embodiments, at least one blower 160 is configured to provide an airflow to both chamber 155 and chamber 175. In some embodiments, the airflow from chamber 155 may be provided to radial outlets 150 and the airflow from chamber 175 may be provided to at least one forward outlet 170. In some embodiments, the blower is further comprised of a switch, further discussed with respect to FIG. 4A herein below, capable of providing airflow to at least one of chamber 155 and 175 in order to provide at least one of: the radial airflow and/or the forward airflow. In some embodiments, each of the blowers is capable of providing air at a rate of 100-1000 liters per minute, for example, 100-200 liters per minute, 200-500 liters per minute, 500-700 liters per minute, 700-1000 liters per minute, and any range and value herein between.

In some embodiments, suction head 100 is further comprised of at least one second blower (also not illustrated), wherein the at least one second blower is configured to provide air to a second chamber in fluid connection to either: the at least one forward outlet 170, or the plurality of radial outlets 150. In some embodiments, suction head 100 is comprised of a single blower 160 and a single chamber 155, wherein the single chamber 155 is in fluid connection with the radial and forward outlets 150 and 170, respectively.

In some embodiments, at least one suction tube 120 may further be connectable to a pump not illustrated. An example for such a pump is illustrated and discussed with respect to FIG. 3 hereinbelow. In some embodiments, all suction tubes 120 may be connected to a single pump. In some embodiments, each suction tube 120 may be connected to a separate pump. In some embodiments, each of the pumps is capable of pumping air at a rate of 5-30 liters per minute, for example, 5-10 liters per minute, 10-20 liters per minute, 20-30 liters per minute and any range and value herein between. In some embodiments, if suction head 100 lacks a sensor, the pump is capable of pumping air at a rate of at least 60 liters per minute.

Reference is now made to FIGS. 1C and 1D which are illustrations of a head for a suction device according to some embodiments of the invention. A suction head 200 may include substantially the same components, elements, and units as suction head 100 discussed hereinabove. Suction head 200 may include at least one suction inlet 210, suction tube 220 in fluid connection with suction inlet 210, a plurality of radial outlets 250, at least one chamber 255 in fluid connection with radial outlets 250, at least one forward outlet 270, and at least one chamber 275 in fluid connection with the at least one forward outlet 270. In some embodiments, suction inlet 210 is configured to provide suction in first direction Z, radial outlets 250 are configured to provide air in radial direction R, and at least one forward outlet 270 is configured to provide air in a second direction Y. In some embodiments, second direction Y is substantially opposite to first direction Z as illustrated.

Reference is now made to FIGS. 2A, 2B, 2C and 2D which are illustrations of a portion of a suction head according to some embodiments of the invention. In some embodiments, radial outlets 150 or 250 of suction head 100 or 200 may provide air in a radial direction R as illustrated in FIG. 2B. In some embodiments, at least one forward outlet 170 or 270 may be configured to provide air in a second direction Y, as further illustrated and discussed hereinbelow. In some embodiments, in the case of suction head 200, one or more suction inlets 210 (e.g., 1, 2, 3 or more suction inlets) may be located around an outer radius of at least one forward outlet 270 as illustrated.

In some embodiments, each suction inlet 110 or 210 may have a port shape comprised of chamfer angle β, wherein the chamfer angle β may be 15-60 degrees, 15-50 degrees, 20-40 degrees, 30-60 degrees, and any range and value herein between.

In some embodiments, radial direction R refers to any direction pointing along a radius from first direction Z. In some embodiments, radial direction R may be in a plurality of directions with respect to the plurality of radial outlets 150 or 250. In some embodiments, radial direction R is substantially perpendicular to first direction Z. In some embodiments, radial direction R may be an angle α with respect to first direction Z (illustrated in FIG. 2C), wherein angle α may be 60-120 degrees, 70-110 degrees, 80-120 degrees, 60-90 degrees, and any range and value herein between.

In some embodiments, in the case that at least one forward outlet 170 or 270 is comprised of more than one outlet, second direction Y may be a plurality of directions with respect to the forward outlets 170 or 270. In some embodiments, second direction Y may be set at a radial angle θ with respect to first direction Z, as illustrated in FIG. 2C. In some embodiments, second direction Y may be offset at a tangential angle ϕ with respect to orthogonal direction X, as illustrated in FIG. 2D, wherein orthogonal direction X is orthogonal of first direction Z. In some embodiments, radial angle θ may be 15-60 degrees, 30-50 degrees, 45-60 degrees, 15-30 degrees and any range and value herein between with respect to first direction Z. In some embodiments, tangential angle ϕ may be 15-60 degrees, 30-50 degrees, 45-60 degrees, 15-30 degrees and any range and value herein between with respect to orthogonal direction X orthogonal of first direction Z.

Reference is now made to FIGS. 2E and 2F showing illustrations of a flow field of a suction head according to some embodiments of the invention. In some embodiments, the flow field of suction head 100 or 200 may be represented by a radial flow illustrated in FIG. 2E or a forward flow illustrated in FIG. 2F, illustrating induced airflows caused by suction head 100 or 200 to detach and collect particles 5 from a surface 7. In some embodiments, the radial and forward airflows may be actuated to switch between each other or act in parallel, as discussed herein below with respect to FIG. 4A.

In some embodiments, a radial flow as illustrated in FIG. 2E occurs when radial outlet 150 or 250 provides air in radial direction R while suction inlet 110 induces suction in first direction Z. In some embodiments, first direction Z is substantially perpendicular to surface 7. In some embodiments, as air is pushed outward in radial direction R, air is concurrently directed towards suction inlet 110 or 210, leading particles 5 towards suction inlet 110.

In some embodiments, a forward flow as illustrated in FIG. 2F occurs when forward outlet 170 provides air in second direction Y while suction inlet 110 induces suction in first direction Z. In some embodiments, first direction Z and second direction Y are substantially perpendicular to surface 7, wherein second direction Y is opposite of first direction Z. In some embodiments, a plurality of forward outlets 170 directing air in second directions Y encompasses a circumference of suction inlet 110, and are set at the tangential and radial angles ϕ and θ discussed hereinabove. In some embodiments, angles ϕ and θ are chosen to induce a vortex flow around first direction Z, to further detach particles 5 from surface 7 to be directed towards suction inlet 110.

Reference is now made to FIG. 3 detailing a suction device 300 according to some embodiments of the invention. Suction device 300 may include suction head 200 (or suction head 100) discussed herein above. In some embodiments, suction device 300 may further include at least one blower 260 configured to provide air to the at least one chamber 255 of suction head 200. Suction device 300 may further include a holder 222 for a sensor 224 for sensing target particles. In some embodiments, sensor 224 may be attached to at least one location in head 200 using an adhesive. Suction device 300 may further include a connector 226 capable of connecting to at least one pump 230 configured to pump air from each suction tube 220 of head 200. As should be understood by one skilled in the art, a similar arrangement may be applied to suction head 100.

Suction device 300 may further include a controller 290 configured to: control components of heads 200 (or 100), according to instructions discussed with respect to FIG. 4A.

In some embodiments, suction head 100 or 200 further comprises a distance sensor (not illustrated) located on suction head 100 or 200, configured to determine the distance between the distance sensor and a target surface comprising target particles. In some embodiments, the distance sensor is configured to send a signal to controller 190 or 290, further configured to determine an air provision rate of the at least one blower 160 or 260 based on the received signal. In some embodiments, the distance sensor may be comprised of at least one of: a laser curtain, configured to direct at least one laser beam in second direction Y, and an ultrasonic transducer, configured to provide an ultrasonic vibration in second direction Y. In some embodiments, the at least one laser beam may be used to illuminate target particles on a surface, to identify the location of particles on the surface. In some embodiments, the ultrasonic vibration may be used to detach particles from a target surface.

In some embodiments, sensor 124 or 224 is capable of sensing a particulate and capable of sending a signal to an external device. In some embodiments, sensor 124 or 224 is capable of detecting at least one chemical and/or physical property of a target particle. For example, the sensor may be configured to detect a specific chemical group, included in the composition of the target particle, using a specific chemical reaction. In yet another example, the sensor may be capable of detecting the conductivity of the target particle.

In some embodiments, suction head 100 or 200 further comprises a heating element located in proximity to at least one of: the at least one suction tube 110 or 210, the at least one chamber 155 or 255, wherein the heating element is further capable of being controlled by controller 190 or 290, respectively. In some embodiments, the heating element is configured to heat the pumped air comprising the target particles, thus minimizing the attachment of the target particles to walls of suction tube 120 or 220.

Reference is now made to FIG. 4A illustrating a suction system 1000 according to some embodiments of the invention. In some embodiments, suction system 1000 is comprised of: head 100 or 200 comprising sensor 124 or 224, at least one pump 130 or 230, at least one blower 160 or 260, and a controller 190 or 290.

In some embodiments, suction system 1000 is further comprised of a switch 165 or 265 configured to actuate blower 160 or 260 to provide air to at least one of: a radial and forward outlet, as discussed hereinabove. In some embodiments, switch 165 or 265 may be configured to actuate provision of airflow between the radial and the forward outlet. In some embodiments, switch 165 or 265 may be configured to provide a radial and forward airflow in parallel, i.e., simultaneously.

In some embodiments, suction system 1000 is configured to induce suction on a surface 7 and identify the presence of at least one target particle collected from surface 7. In some embodiments, controller 190 or 290 is configured to: control the at least one pump 130 or 230 to continuously pump air via suction head 100 or 200, and control the at least one blower 160 or 260 to control at least one of: a radial outflow via the radial outlets 150 or 250, and a forward outflow via the forward outlets 170 or 270. In some embodiments, sensor 124 or 224 of head 100 or 200 is further capable of sending a signal to controller 190 or 290, based on analysis performed on particles collected from surface 7.

Reference is now made to FIG. 4B, which is a flowchart of a method of controlling a suction device according to some embodiments of the invention. In some embodiments, steps 410 to 420 may be used to control suction system 1000. In some embodiments, steps 410 to 420 may be controlled by controller 190 or 290 of suction device 100 or 200, respectively or any other suitable controller.

In step 410, a suction intake may be activated to induce suction of particles on a surface. In step 420, at least one of: a radial jet and a forward flow may be controlled to separate particles from a surface, as discussed hereinabove. In some embodiments, controllers 190 or 290 may control blowers 160 or 260 and/or switches 165 or 265 to first provide flow to radial outlets 150 or 250, halt the flow from radial outlets 150 or 250 and provide a forward flow (e.g., in the form of a pulse or a continuous jet) via forward outlets 170 or 270. In some embodiments, controllers 190 or 290 may control blowers 160 or 260 and/or switches 165 or 265 based on an instruction received from a user interface. In some embodiments, the user interface may include a button to be pushed by a user, a touchscreen to be touched by the user and the like. Upon receiving the instruction, controllers 190 or 290 may halt the flow from radial outlets 150 or 250 and provide the forward flow from forward outlets 170 or 270, for example, a short pulse of flow. Upon finalizing the provision of the forward flow, controllers 190 or 290 may resume the flow from radial outlets 150 or 250.

In some embodiments, controllers 190 or 290 may control the alternating between the forward flow and the radial flow based on a predetermined sequence. In some embodiments, step 420 may be repeated in order to induce suction of particles on a surface. In some embodiments, step 420 may be controlled for a predetermined time period, for example, to alternate between radial and forward airflows. In some embodiments, step 420 may be controlled to provide both a radial jet and a forward flow, for example, to provide a simultaneous radial and forward flow.

In some embodiments, the method may further include receiving a distance measurement from a distance sensor attached to device 100 or device 200. In some embodiments, the measurement may be indicative of the distance between device 100 or 200 suction inlets 110 or 210 to a target surface (e.g., surface 7). In some embodiments, controllers 190 or 290 may be configured to control the capacities of at least one of pumps 130 or 230 and blowers 160 or 260 based on the received distance measurement. For example, if the distance to a target surface is reduced, the required capacity of said blowers or pumps may be reduced to maintain efficient suction. In another example, controllers 190 or 290 may be configured to shut down pumps 130 or 230 and blowers 160 or 260 if the measured distance is above a predetermined threshold value, as above this value the suction is ineffective.

In some embodiments, the method may include providing heat to at least a portion of suction tubes 120 or 220 and optionally also chambers 155, 175, 255 and/or 275. In some embodiments, the heating may decrease the tendency of particles 5 to become attached to the walls of suction tubes 120 or 220. In some embodiments, said heating may further increase the detachment of particles 5 on a target surface (e.g., surface 7), for example, if provided air from the radial or forward outlets are heated.

In some embodiments, the method may include analyzing and identifying at least one target particle in the collected particles. In some embodiments, as airflow comparing the collected particles is reaching sensor 124 or 224, target particles may react/interact with at least one component of sensor 124 or 224. In some embodiments, the reaction may produce a signal to be received by controllers 190 or 290. In some embodiments, controllers 190 or 290 may further be configured to display an alert indicating an identification of a target particle, send the alert to an external device or control an external device (e.g., close a gate) based on the identification.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A head for a suction device, comprising:
at least one suction inlet, configured to provide suction in a first direction;
at least one suction tube, wherein each suction tube is in fluid connection to each suction inlet, wherein each suction tube is further connectable to a pump;
a plurality of radial outlets, configured to provide air in a radial direction, wherein the radial outlets are in fluid connection with at least one chamber connectable to at least one blower, and
at least one forward outlet configured to provide air in a second direction, wherein each forward outlet is in fluid connection to the at least one chamber connectable to the at least one blower.

2. The head of claim 1, further comprising a holder for holding a sensor.

3. The head of claim 2, wherein the holder is located in the suction tube.

4. The head according to claim 1, wherein the second direction is opposite to the first direction.

5. The head according to claim 1, wherein the second direction is set at: a tangential angle of 15-60 degrees along a plane orthogonal of the first direction, and a radial angle of 15-60 degrees with respect to the first direction.

6. The head according to claim 1, wherein the radial direction is 60-120 degrees with respect to the first direction.

7. The head according to claim 1, wherein a diameter of the head is 60-120 mm.

8. The head according to claim 1, wherein the diameter of each at least one suction inlet is 4-10 mm.

9. The head according to claim 1, wherein the distance from each at least one suction inlet to each forward outlet is 5-20 mm.

10. The head according to claim 1, wherein the at least one forward outlet comprises a plurality of evenly distributed ports, circumferentially located around an outer radius of the at least one suction inlet.

11. (canceled)

12. The head according to claim 1, wherein the plurality of radial outlets comprises a plurality of evenly spaced ports, located on a wall of the head in the radial direction.

13. (canceled)

14. The head according to claim 1, wherein each suction inlet port further comprises a countersink inlet port selected from: a fillet, a chamfer.

15. The head according to claim 1, wherein each of the at least one pump is capable of pumping air at a rate of 5-30 liters per minute.

16. The head according to claim 1, wherein the at least one blower is capable of providing air at a rate of 100-1000 liters per minute.

17. The head according to claim 1, wherein the head is further comprised of a switch capable of actuating to provide air to at least one of: the radial outlets, the at least one forward outlet.

18. The head according to claim 1, further comprising a controller configured to:
control the at least one pump to continuously pump air via the at least one suction tube;
control the at least one blower to, either separately or simultaneously:
control a radial airflow via the radial outlets, and
control a pulsed or continuous airflow via the forward outlets.

19. The head according to claim 16, further comprising a distance sensor located on the head, wherein the controller is capable of receiving a signal from the distance sensor; and controlling the air provision rate of the at least one blower based on a signal from the distance sensor.

20.-27. (canceled)

28. A suction system, comprising:
a sensor;
at least one pump;
at least one blower;
a suction head, comprising:
at least one suction inlet, configured to provide suction in a first direction;
at least one suction tube, wherein each suction tube is in fluid connection to each suction inlet, wherein each suction tube is further connected to each pump;
a plurality of radial outlets, configured to provide air in a second direction, wherein the radial outlets are in fluid connection with at least one chamber connected to the at least one blower;
at least one forward outlet configured to provide air in a second direction, wherein each forward outlet is in fluid connection to the at least one chamber connected to the at least one blower, and
a controller, configured to:
control the at least one pump to continuously pump air via the at least one suction tube, and
control the at least one blower to, either separately or simultaneously:
control a radial airflow via the radial outlets, and
control a forward airflow via the forward outlets.

29. A method of controlling a suction device, comprising:
activating a suction intake to induce suction of particles on a surface;
controlling at least one of: a radial jet and a forward flow, to separate particles from a surface,
wherein the suction device comprises a head, comprising:
at least one suction inlet, configured to provide suction in a first direction;
at least one suction tube, wherein each suction tube is in fluid connection to each suction inlet, wherein each suction tube is further connectable to a pump;
a plurality of radial outlets, configured to provide air in a radial direction, wherein the radial outlets are in fluid connection with at least one chamber connectable to at least one blower, and
at least one forward outlet configured to provide air in a second direction, wherein each forward outlet is in fluid connection to the at least one chamber connectable to the at least one blower.

30. The method according to claim 29, wherein the radial jet and forward flow are alternated, wherein alternation is for a predetermined time period.
